(19) United States
(12) Patent Application Publication
(10) Pub. No.: US 2007/0171651 A1
(43) Pub. Date: Jul. 26, 2007

(54) Backlight assembly that increases color uniformity and display device having the same

(76) Inventors: Se-Ki Park, Gyeonggi-do (KR); Gi-Cherl Kim, Gyeonggi-do (KR); Seok-Hyun Nam, Seoul (KR); Joo-Woan Cho, Seoul (KR)

Correspondence Address: MACPHERSON KWOK CHEN & HEID LLP, 2033 GATEWAY PLACE, SUITE 400, SAN JOSE, CA, 95110, US

(21) Appl. No.: 11/656,594

(22) Filed: Jan. 22, 2007

(30) Foreign Application Priority Data
Jan. 23, 2006 (KR) 2006-6737

(51) Int. Cl. F21V 5/00

(52) U.S. Cl. 362/330; 362/231; 362/244

(57) ABSTRACT

A backlight assembly that improves color uniformity is presented. The backlight assembly includes a plurality of point light sources, an optical member on the point light sources, and a reflecting plate that is positioned to receive light that is reflected by the optical member. The point light sources includes a red light emitting diode generating red light, a green light emitting diode generating green light, and a blue light emitting diode generating blue light. The optical member transmits white light formed by mixing at least some of the red, green and blue lights and reflects the untransmitted portion of the red, green and blue lights. The reflecting plate, which receives the reflected light from the optical member, includes a plurality of patterns that reflect the incident red, green and blue lights, essentially “recycling” the light that did not get transmitted in the first pass.

### CROSS-REFERENCE TO RELATED APPLICATIONS

The present application claims priority from Korean Patent Application No. 2006-06737 filed on Jan. 23, 2006, the disclosure of which is hereby incorporated herein by reference in its entirety.

### BACKGROUND OF THE INVENTION

1. Field of the Invention

The present invention relates to a backlight assembly and a display device having the backlight assembly. More particularly, the present invention relates to a backlight assembly capable of increasing color uniformity and a display device having the backlight assembly.

2. Description of the Related Art

The backlight assembly of a liquid crystal display (LCD) device is classified into a direct illumination type backlight assembly and an edge illumination type backlight assembly based on the location of the light source. The direct illumination type backlight assembly includes a plurality of light sources arranged under a display panel. The edge illumination type backlight assembly includes a light source positioned along a side of a light guiding plate.

When the light source includes a light emitting diode, the light source typically has a red light emitting diode, a green light emitting diode and a blue light emitting diode to increase color reproducibility. The red light emitting diode generates red light, the green light emitting diode generates green light, and the blue light emitting diode generates blue light. The red, green and blue lights generated from the red, green and blue light emitting diodes are mixed appropriately to generate white light, and the LCD device displays an image using the white light. Thus, the LCD device includes an element that mixes the red, green and blue lights.

The light emitting diodes are grouped and sorted based on a wavelength, luminance and a driving voltage. Therefore, the LCD device requires a backlight assembly that generates light regardless of sorting of the light emitting diodes with respect to optical characteristics and light emitting type.

### SUMMARY OF THE INVENTION

The present invention provides a backlight assembly capable of increasing color uniformity. The present invention also provides a display device having the above-mentioned backlight assembly.

In one aspect, the invention is a backlight assembly that includes a plurality of point light sources, an optical member, and a reflecting plate. The point light sources includes a red light emitting diode generating red light, a green light emitting diode generating green light, and a blue light emitting diode generating blue light. The optical member is on the point light emitting diodes and receives the red light, the green light, the blue light, and white light formed by mixing at least some of the red, green and blue lights and to reflect a remaining portion of the red, green and blue lights. The reflecting plate is positioned to receive light that is reflected by the optical member, and has a reflection structured portion formed thereon.

In another aspect, the invention is a display device in accordance with another aspect of the present invention includes a plurality of point light sources, an optical member, a reflecting plate and a display panel. The point light sources generate red, green and blue lights. The optical member is on the point light sources to transmit white light formed by mixing a portion of the red, green and blue lights and to reflect an untransmitted portion of the red, green and blue lights. The reflecting plate has a plurality of openings through which the point light sources extend, and a plurality of patterns for diffusing the untransmitted portion of the red, green and blue lights, thereby increasing color uniformity. The display panel displays an image by using the white light exiting the optical member.

### BRIEF DESCRIPTION OF THE DRAWINGS

The above and other advantages of the present invention will become more apparent by describing in detail example embodiments thereof with reference to the accompanying drawings, in which:

FIG. 1 is an exploded perspective view illustrating a backlight assembly in accordance with one embodiment of the present invention;

FIG. 2 is a cross-sectional view taken along the line I-I′ shown in FIG. 1;

FIG. 3 is an enlarged perspective view illustrating the portion ‘A’ shown in FIG. 1;

FIG. 4 is a graph illustrating a relationship between a bottom length of each pyramid having a constant height and the color uniformity of a backlight assembly in accordance with one embodiment of the present invention;

FIG. 5 is a graph illustrating a relationship between a bottom length of each pyramid having a height that is substantially proportion to the bottom length and the color uniformity of a backlight assembly in accordance with one embodiment of the present invention;

FIG. 6 is a perspective view illustrating a backlight assembly in accordance with another embodiment of the present invention;

FIG. 7 is a graph illustrating a relationship between a bottom length of each of embossing portions having a constant height and the color uniformity of a backlight assembly in accordance with another embodiment of the present invention;

FIG. 8 is a graph illustrating a relationship between an interval between adjacent embossing portions having a substantially same size and the color uniformity of a backlight assembly in accordance with another embodiment of the present invention;

FIGS. 9A to 9C are plan views illustrating arrangements of embossing portions in accordance with another embodiment of the present invention; and

FIG. 10 is a cross-sectional view illustrating a display device in accordance with one embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

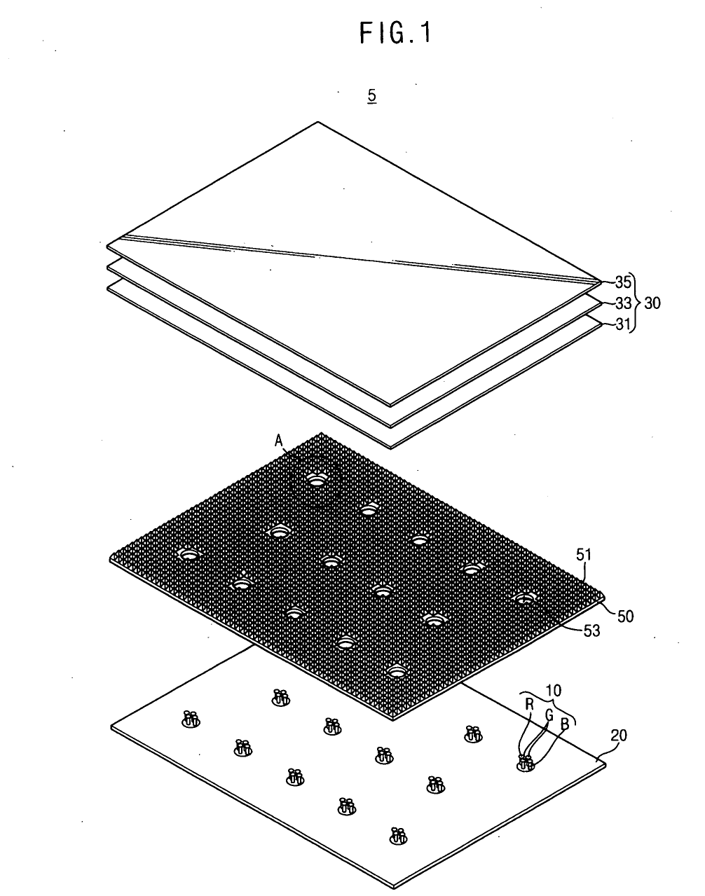

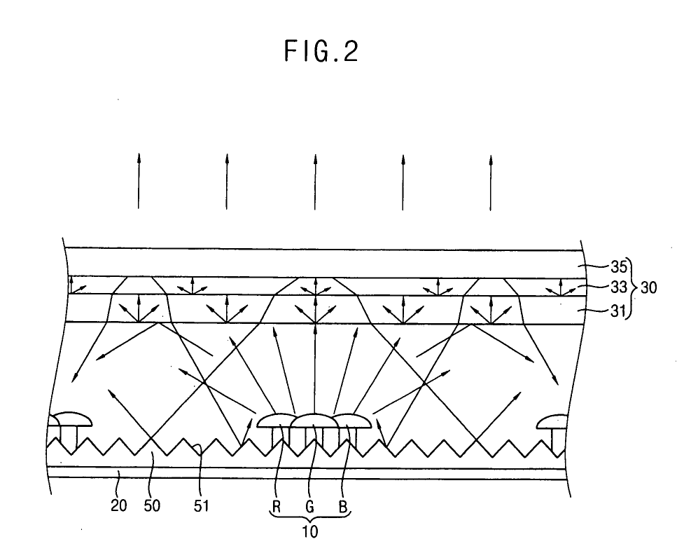

FIG. 1 is an exploded perspective view illustrating a backlight assembly in accordance with one embodiment of the present invention. FIG. 2 is a cross-sectional view taken along the line I-I′ shown in FIG. 1.

Referring to FIGS. 1 and 2, the backlight assembly 5 includes a plurality of point light sources 10, an optical member 30 and a reflecting plate 50.

The backlight assembly 5 may further include a power supply printed circuit board (PCB) 20. The point light sources 10 are arranged on the power supply PCB 20. The power supply PCB 20 is electrically connected to an externally provided power supplying part (not shown) to receive a driving current from the externally provided power supplying part to drive the point light sources 10. A conductive pattern is formed on the power supply PCB 20, and the point light sources 10 are electrically connected to the conductive pattern.

The point light sources 10 may be aligned in three lines that extend along the length of the power supply PCB 20. At least some of the point light sources 10 on the two lines that are separated by a middle line are aligned with each other. At least some of the point light sources 10 on the middle or center line of the power supply PCB 20 may be arranged in a staggered manner with respect to the portion of the point light sources 10 on the two neighboring lines.

Depending on the embodiment, the point light sources 10 may be arranged in various configurations such as a substantially pentagonal shape, a substantially hexagonal shape, etc.

Each of the point light sources 10 includes a plurality of light emitting diodes R, G, and B. Particularly, the point light source 10 may include one red light emitting diode R, two green light emitting diodes G and one blue light emitting diode B. The red, green and blue light emitting diodes R, G and B generate red, green and blue lights, respectively.

The red, green and blue light emitting diodes R, G and B may be arranged in a substantially diamond configuration. For example, the red, green and blue light emitting diodes R, G and B may be positioned at the four corners of the diamond. The red and blue light emitting diodes R and B may be aligned to form a line along the length of the power supply PCB 20, and the two green light emitting diodes G may be aligned to form a line across the width of the power supply PCB.

Alternatively, the red, green and blue light emitting diodes R, G and B may be arranged in other configurations. For example, the red, green and blue light emitting diodes R, G and B may be positioned at the three corners of a substantially triangular configuration.

In FIGS. 1 and 2, the red, green and blue light emitting diodes R, G and B are top emitting type light emitting diodes. Particularly, each of the red, green and blue light emitting diodes R, G and B includes a light emitting chip generating one of the red, green and blue lights and a lens on the light emitting chip. The lens is on a light path of the light generated from the light emitting chip. The lens may have a substantially semi-circular cross-section or a substantially elliptical cross-section. Thus, each of the red, green and blue lights having passed through the lens has an exiting angle of about 0 degrees to +70 degrees with respect to a virtual normal line of each of the red, green and blue light emitting diodes R, G and B, and an amount of the light having an exiting angle of more than about +70 degrees with respect to the virtual normal line of the light-emitting surface is negligible.

In some embodiments, each of the red, green and blue light emitting diodes R, G and B may be side emitting type light emitting diodes.

The optical member 30 is on the point light sources 10 so that a white light that is formed by mixing some of the red, green and blue lights exits the optical member 30, and the portion of the red, green and blue lights that is not used for the white light is reflected from the optical member 30. The optical member 30 may include a diffusion plate 31, a diffusion sheet 33 and a dual brightness enhancement film (DBEF) 35. The diffusion plate 31, the diffusion plate 33 and the DBEF 35 may be stacked on the point light sources 10, in sequence.

The red, green and blue lights have exiting angles so that allow them to mix and form a first white light at a predetermined distance from the point light sources 10. The first white light formed by mixing the red, green and blue lights has a first color uniformity. The first color uniformity of the first light may be lower than the color uniformity for displaying an image.

The diffusion plate 31 reflects the portions of the red, green and blue lights that are not mixed and a portion of the first white light, and the unreflected portion of the first white light passes through the diffusion plate 31 to form a second white light. In FIGS. 1 and 2, the diffusion plate 31 is spaced apart from the point light sources 10 by a set distance to mix the red, green and blue lights.

The diffusion plate 31 may have a substantially planar shape, and may contain a high polymer resin having various characteristics such as high light transmittance, high heat resistance, high chemical resistance, high mechanical strength, etc. Examples of the high polymer that can be used for the diffusion plate 31 include polymethylmethacrylate, polyamide, polyimide, polypropylene, polyurethane, etc. The diffusion plate 31 may further include a plurality of diffusion beads in a base plate having the high polymer to increase diffusivity of the diffusion plate 31.

The second white light exiting the diffusion plate 31 has a second color uniformity that is greater than the first color uniformity of the first white light. As shown in FIGS. 1 and 2, the second white light may be mixed again to generate white light having an even increased color uniformity for displaying the image.

The diffusion sheet 33 may have a substantially same material as the diffusion plate 31, and may be flexible. The diffusion sheet 33 is on the diffusion plate 31 to diffuse the second white light, thereby generating a third white light. The third white light has a third color uniformity that is greater than the second color uniformity. The diffusion plate 31 and the diffusion sheet 33 may diffuse the light in a direction that is substantially perpendicular to the optical member 30. As shown in FIGS. 1 and 2, the third white light may be mixed again to generate white light having an even increased color uniformity for displaying the image.

Therefore, the backlight assembly 5 may further include the DBEF 35 to increase the color uniformity of the third white light in a horizontal direction substantially parallel to the optical member 30. Thus, the third white light may be recycled to increase the color uniformity.

The DBEF 35 is on the diffusion sheet. The DBEF 35 increases the luminance of the backlight assembly 5. In FIGS. 1 and 2, the DBEF 35 is a film manufactured by 3M INC. U.S.A.

Particularly, the third white light is divided into an S wave and a P wave. The S wave vibrates substantially perpendicularly to the P wave. The S wave may be changed into the P wave using the DBEF 35. A polarizer transmits the P wave and blocks the S wave so that luminance is decreased. However, the DBEF 35 changes the S wave into the P wave so that the luminance of the third white light is not decreased. Thus, the DBEF 35 allows a greater amount of light to pass through the polarizer.

The DBEF 35 has a plurality of layers having various refractive indexes. The third white light incident on the DBEF 35 is refracted and reflected on the layers having the various refractive indexes. Thus, the DBEF 35 emits a fourth white light having greater color uniformity than the third white light. Particularly, a portion of the third light passes through the DBEF 35. The remaining portion of the third light is reflected from the DBEF 35 toward the diffusion sheet 33 and the diffusion plate 31 to be recycled.

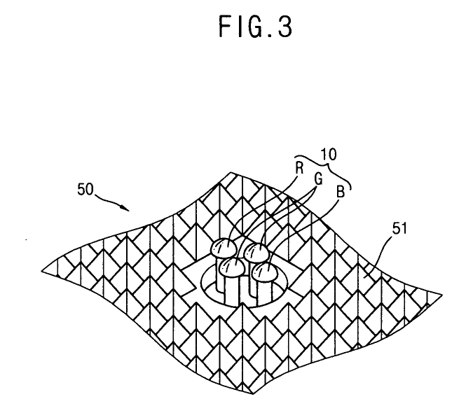

FIG. 3 is an enlarged perspective view illustrating the portion ‘A’ shown in FIG. 1.

Referring to FIGS. 1 to 3, the reflecting plate 50 is positioned around the point light sources 10, which extend through the openings 53, and includes a plurality of patterns. The patterns diffuse the light reflected from the optical member 30 to increase the color uniformity in the horizontal direction substantially parallel to the optical member 30. Thus, the color uniformity of the light is increased. A highly reflective material may be printed on a flexible base film to form the patterns. Alternatively, the flexible base film may be pressed to form the reflecting plate 50.

The patterns include a plurality of reflecting structured portions 51. Each of the reflecting structured portions 51 has a polygonal pyramid shape. Adjacent reflecting structured portions 51 share a common edge.

In FIGS. 1 to 3, each of the reflecting structured portions 51 has a pyramid shape with a rectangular base and triangular side surfaces. The bottom surface of the reflecting structured portion 51 may be substantially square. Each of the reflecting structured portions 51 may have a triangular pyramid shape. Alternatively, each of the reflecting structured portions 51 may have a conical shape.

A plurality of openings 53 are formed in the reflecting plate 50 and positioned to be aligned with the point light sources 10. When the power supply PCB 20 is disposed under the reflecting plate 50, the point light sources 10 are inserted into the openings 53. The point light sources 10 may protrude from the patterns of the reflecting plate 50.

Each of the point light sources 10 may include the red, green and blue light emitting diodes R, G and B, and the number of the red light emitting diode R, the number of the green light emitting diode G and the number of the blue light emitting diode B may be one, two and one, respectively. The red, green and blue light emitting diodes R, G and B are arranged in the diamond shape in each of the openings 53.

The red, green and blue lights generated from the red, green and blue light emitting diodes R, G and B and the first white light may be partially reflected by the diffusion plate 31. In addition, the second white light may be partially reflected by the diffusion sheet 33, and the third white light may be partially reflected by the DBEF 35.

The lights reflected by the optical member 30, herein referred to as the “reflection light,” is recycled. The reflection light is reflected again by the reflecting plate 50. The reflecting structured portions 51 of the reflecting plate 50 reflect the reflection light so that the color uniformity of the reflection light in the horizontal direction is increased. Thus, the color uniformity is increased so that the recycled white light has greater color uniformity than the third white light.

The color uniformity may be changed by the shape of each of the patterns.

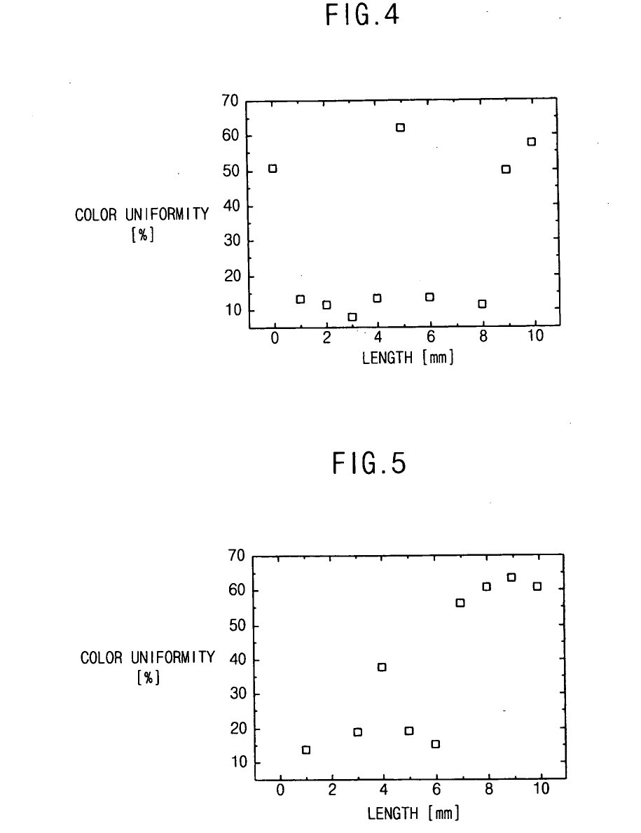

FIG. 4 is a graph illustrating the relationship between the bottom length of each pyramid on the reflecting plate 50 and the color uniformity of a backlight assembly in accordance with one embodiment of the present invention. The pyramids on the reflection plate 50 have a constant height. The bottom length is a length of a light crossing a center of the bottom surface of each pyramid. For example, in the case of a triangle, the bottom length is between a vertex and the midpoint of the opposite side.

In one embodiment, the diagonal length of the backlight assembly 5 is sixteen inches. A prometric apparatus detected color uniformity on a two dimensional image, and the color uniformity of the two dimensional image was measured and simulated.

In FIG. 4, the horizontal axis represents the bottom length of the pyramid, and the vertical axis represents the color uniformity. A two dimensional image was divided into a plurality of differential areas Δuv with reference to a u-axis and a v-axis that was substantially perpendicular to the u-axis of the two dimensional images. A percentage of differential areas Δuv having a color difference of less than 0.006 was detected and plotted on the graph. The color uniformity of the white light generated from the backlight assembly 5 increased with the percentage of the differential areas Δuv having the color difference of less than 0.006.

In FIG. 4, when the reflecting plate 50 did not have the patterns and had a substantially flat surface (i.e., length=about 0), the percentage of the differential areas Δuv having the color difference of less than 0.006 was about 50.62%, as shown.

The height of the pyramid was about 1 mm in the embodiment used to obtain FIG. 4. The bottom length of the pyramid shape was changed, and the two dimensional image was simulated to obtain the percentage of the differential areas Δuv having the color difference of less than 0.006. Therefore, the graph had two peaks of high color uniformity. When the bottom length of the pyramid shape was about 5 mm and about 10 mm, the percentage of the differential areas Δuv having the color difference of less than 0.006 was about 62.06%.

Therefore, when a ratio of the height to the bottom length of the pyramid shape was about 1.0:4.9˜1.0:5.1 or about 1.0:9.9˜1.0:10.1, the color uniformity was maximized.

Alternatively, each of the reflecting structured portions 51 may have the triangular pyramid shape or the conical shape. The reflecting structured portion 51 having the triangular pyramid shape or the conical shape also has optimized height and length. The ratio of the height to the bottom length of the reflecting structured portion 51 having the triangular pyramid shape or the conical shape may also be about 1.0:4.9˜1.0:5.1 or about 1.0:9.9˜1.0:10.1.

FIG. 5 is a graph illustrating a relationship between the bottom length of each pyramid and the color uniformity of a backlight assembly in accordance with another embodiment of the present invention. In this embodiment, the height of the pyramid increased in substantially proportion to the bottom length.

Each of the pyramids had a constant ratio of height:bottom length. The size of the pyramid was changed to detect the color uniformity of light generated from the backlight assembly 5. The horizontal axis represents the bottom length of the pyramid.

In the particular embodiment used for FIG. 5, the ratio of the height to the bottom length of the pyramid was about 1:1. When the bottom length of the pyramid was about 7 mm to about 11 mm, the percentage of the differential areas Δuv having the color difference of less than 0.006 was about 60.55%. Therefore, the color uniformity was maximized.

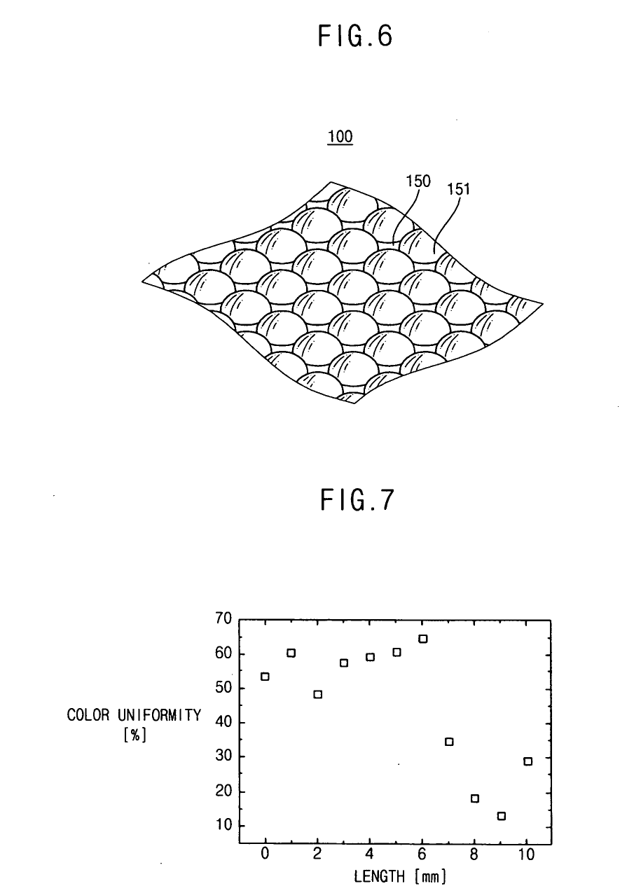

FIG. 6 is a perspective view illustrating a backlight assembly in accordance with another embodiment of the present invention.

Referring to FIG. 6, the backlight assembly 100 includes a plurality of point light sources (not shown), an optical member (not shown) and a reflecting plate 150. The backlight assembly of FIG. 6 is generally the same as in FIGS. 1 to 3 except for the reflecting plate. Thus, the same reference numerals will be used to refer to the same or like parts as those described in FIGS. 1 to 3 and any further explanation concerning the above elements will be omitted.

The reflecting plate of FIG. 6 is the same as in FIGS. 1 to 3 except for the shape of the reflecting structured portions. Thus, any further explanation concerning the above elements will be omitted.

Each of the reflecting structured portions 151, which is dome-shaped, has a substantially semicircular cross-section. The reflecting structured portions 151 may include a plurality of embossing portions. A bottom surface of each of the embossing portions has a substantially circular shape, a substantially elliptical shape, etc. The bottom surfaces of the embossing portions may partially overlap with or touch each other. Alternatively, the embossing portions may be spaced apart from each other. In some embodiments, some embossing portions have overlapping or touching bottom portions while other bottom surfaces of the embossing portions are spaced apart from each other.

FIG. 7 is a graph illustrating a relationship between the bottom length of each of embossing portions and the color uniformity of a backlight assembly in accordance with another embodiment of the present invention. The embossing portions used for FIG. 7 have a constant height.

In the embodiment used for FIG. 7, the bottom surfaces of the embossing portions contact each other. The embossing portions had constant height, and the bottom lengths of the embossing portions varied. The color uniformity of the backlight assembly was detected using a substantially same method as for FIG. 4.

Generally, the reflecting structured portions 151 having semicircular cross->sections had greater color uniformity than the reflecting structured portion having the pyramid shape. A comparison of FIGS. 4 and 7 indicates that color uniformity data of the reflecting structured portions 151 having the semicircular cross-section are more stabilized than those of the reflecting structured portions having the pyramid shape.

When the bottom length of each of the embossing portions was about 6 mm, the color uniformity is maximized. The ratio of the height to the bottom length of each of the embossing portions was about 1.0:2.9 to about 1.0:3.1.

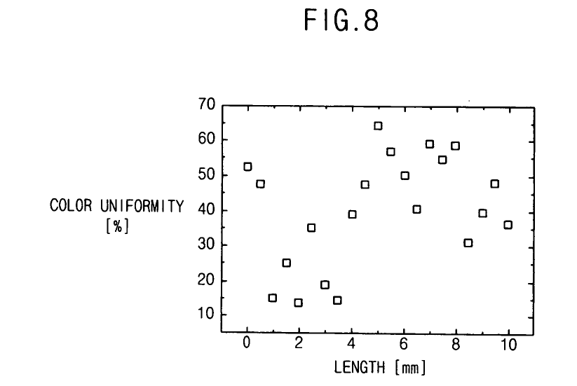

FIG. 8 is a graph illustrating a relationship between the interval between adjacent embossing portions and the color uniformity of a backlight assembly in accordance with another embodiment of the present invention. The embossing portions used for FIG. 8 have a substantially same size.

Referring to FIG. 8, the height of each of the embossing portions was substantially the same as the radius of a bottom surface of the embossing portion, which is half of the bottom length of the embossing portion. The bottom length of the embossing portion was about 6 mm. The distance between adjacent embossing portions was varied, and the color uniformity was detected.

In the embodiment used for FIG. 8, when an interval between bottom surfaces of the adjacent embossing portions was about 4.8 mm, the color uniformity was maximized. A ratio between the height of each of the embossing portions, the radius of the embossing portion, and the interval between the adjacent embossing portions was about 1.0:1.0:0.7 to about 1.0:1.0:0.9.

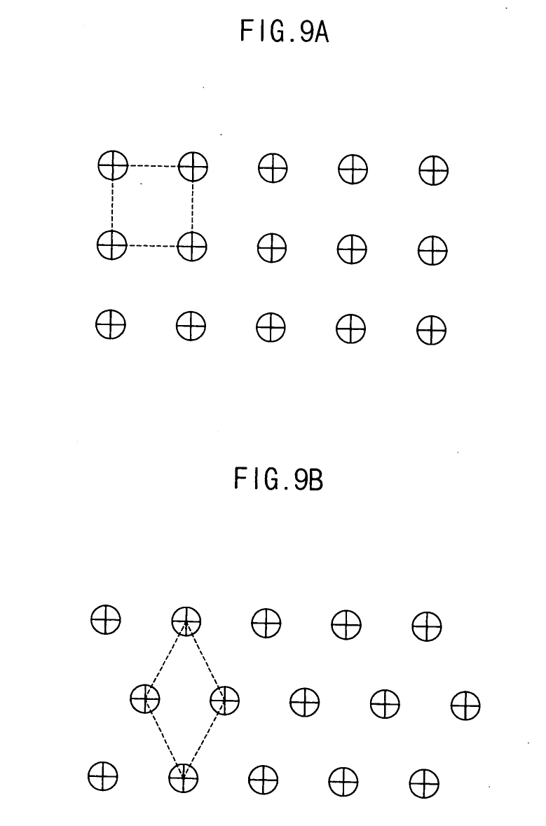

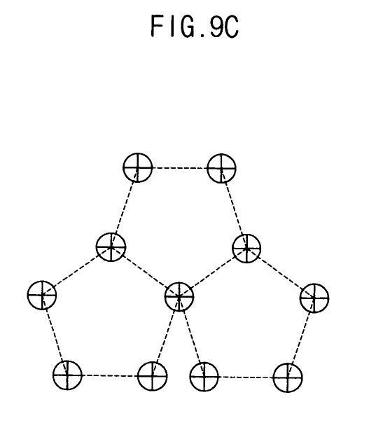

FIGS. 9A to 9C are plan views illustrating the arrangements of embossing portions in accordance with another embodiment of the present invention.

Referring again to FIG. 8, when the bottom surfaces of the embossing portions are spaced apart from each other, the color uniformity of white light generated from a backlight assembly 100 is changed by an arrangement of the embossing portions. In order to increase the color uniformity, the embossing portions are arranged on the reflecting plate 150 at a constant density.

Referring to FIG. 9A, the embossing portions may be arranged in a substantially rectangular configurations. Referring to FIG. 9B, the embossing portions may be arranged in a substantially staggered configuration that forms diamond shapes. Referring to FIG. 9C, the embossing portions may be arranged in a substantially pentagonal configuration. There are many possible configurations for the embossing portions that are not specifically shown here.

In FIGS. 1 to 9C, the reflecting structured portions 151 are a plurality of protrusions that extend from a surface of the reflecting plate 150. Alternatively, the reflecting structured portions 151 may be a plurality of recesses that dip down from the surface of the reflecting plate 150. The recessed reflecting structured portions 151 may also diffuse the light in the horizontal direction substantially parallel to the surface of the reflecting plate 150.

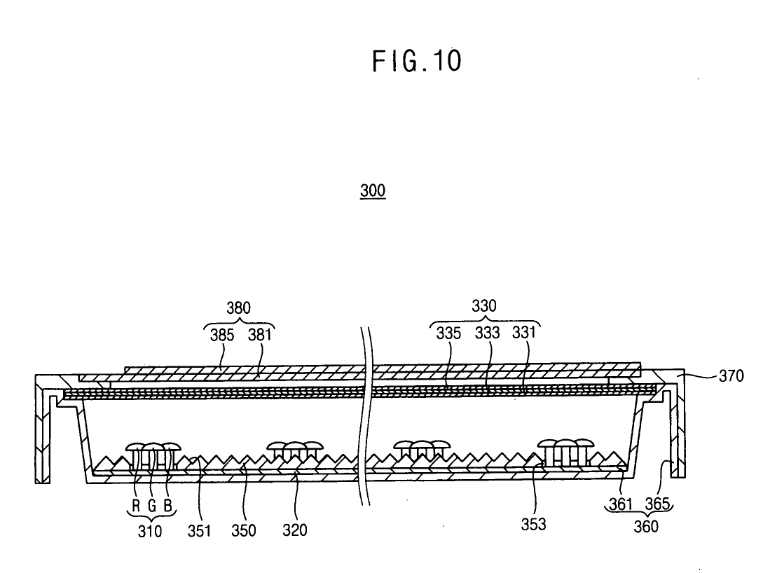

FIG. 10 is a cross-sectional view illustrating a display device in accordance with one embodiment of the present invention.

Referring to FIG. 10, the display device 300 includes a plurality of point light sources 310, an optical member 330, a reflecting plate 350 and a display panel 380.

The point light sources 310 of FIG. 10 are the same as in FIGS. 1 to 3. Thus, any further explanation concerning the above elements will be omitted. The point light sources 310 generate red, green and blue lights. In one embodiment, the point light sources 310 include red, green and blue light emitting diodes R, G and B.

The optical member 330 and the reflecting plate 350 of FIG. 10 are the same as in FIGS. 1 to 3. Thus, any further explanation concerning the above elements will be omitted. Alternatively, the reflecting plate 350 of FIG. 10 may also be the same as in FIG. 6.

The red, green and blue lights generated from the point light sources 310 are mixed to form white light, and are incident into the optical member 330. The optical member 330 transmits a portion of the light incident on the optical member 330 and reflects the untransmitted portion of the light. The color uniformity of the reflected light is low. The reflected light that is reflected from the optical member 330 is reflected again from the reflecting plate 350. When the reflected light is reflected again from the reflecting plate 350, and the reflecting plate 350 diffuses the light in a horizontal direction of the display device 300. The light reflected from the reflecting plate 350 is again directed to the optical member 330. Therefore, white light having increased color uniformity exits the optical member 330.

The display device 300 may further include a receiving container 360 and a power supply PCB 320. The receiving container 360 includes a bottom plate 361 and a sidewall 365. The sidewall 365 is on a side of the bottom plate 361 to form a receiving space. A stepped portion may be formed on the sidewall 365.

The power supply PCB 320 is on the bottom plate 361. The power supply PCB 320 receives a driving current for driving the point light sources 310 from an external power supplying part. The point light sources 310 are arranged on the power supply PCB 320.

The reflecting plate 350 is on the power supply PCB 320, and the point light sources 310 extend through openings 353 formed in the reflecting plate 350.

The optical member 330 is supported by the stepped portion formed on the sidewall 365 so that the optical member 330 is spaced apart from the point light sources 310.

The display device 300 may further include a middle mode 370 that is supported by the optical member 330, and is combined with the receiving container 360.

The display panel 380 is on a guiding groove formed on the middle mode 370, and displays an image using the white light exiting the optical member 330. The middle mold 370 presses a peripheral region of the optical member 330, and supports the display panel 380. For example, the middle mold 370 may include a synthetic resin. The display panel 380 includes a first substrate 381, a second substrate 385 and a liquid crystal layer (not shown).

The first substrate 381 includes a lower substrate and a plurality of pixel electrodes formed on the lower substrate in a matrix shape. The pixel electrodes include a transparent conductive material. The first substrate 381 may further include a plurality of switching elements. Each of the switching elements applies a pixel voltage to each of the pixel electrodes.

The second substrate 385 is on the first substrate 381. The second substrate 385 includes an upper substrate and a plurality of color filters formed on the upper substrate. The color filters are positioned over the pixel electrodes and include red, green and blue color filters. Each of the color filters transmits light having a predetermined wavelength so that a color image is displayed on the display panel 380. The second substrate 385 may further include a common electrode on substantially the entire surface of the second substrate 385. The common electrode faces the pixel electrodes and includes a transparent conductive material.

Liquid crystals of the liquid crystal layer vary their arrangement in response to an electric field formed between the pixel electrodes and the common electrode, and thus the transmission level of the white light exiting the optical member 330 changes with the electric field. Thus, an image having a predetermined gray scale is displayed on the display device 300.

According to the present invention, the backlight assembly having the red, green and blue light emitting diodes includes a reflecting plate having the patterns to mix the red, green and blue lights. The red, green and blue light emitting diodes may be arranged on a lower portion of the backlight assembly of a direct illumination type. Therefore, the color uniformity of the white light generated from the backlight assembly is increased and the image display quality is improved.

This invention has been described with reference to the exemplary embodiments. It is evident, however, that many alternative modifications and variations will be apparent to those having skill in the art in light of the foregoing description. Accordingly, the present invention encompasses all such alternative modifications and variations that fall within the spirit and scope of the appended claims.

What is claimed is:

1. A backlight assembly comprising:
a plurality of point light sources including:
a red light emitting diode generating red light;
a green light emitting diode generating green light; and
a blue light emitting diode generating blue light;
an optical member on the point light sources, the optical member receiving the red light, the green light, the blue light, and white light formed by mixing at least some of the red, green, and blue lights; and
a reflecting plate positioned to receive light that is reflected by the optical member, the reflecting plate having a reflecting structured portion formed thereon.

2. The backlight assembly of claim 1, wherein the reflecting plate comprises a plurality of openings through which the point light sources extend.

3. The backlight assembly of claim 2, wherein one red light emitting diode, two green light emitting diodes and one blue light emitting diode extend through each of the openings of the reflecting plate.

4. The backlight assembly of claim 3, wherein the red, green and blue light emitting diodes are arranged in a substantially diamond configuration with the two green light emitting diodes positioned at opposite corners from each other.

5. The backlight assembly of claim 1, wherein the optical member comprises a diffusion sheet that diffuses the red, green and blue lights.

6. The backlight assembly of claim 1, wherein the reflecting structured portion has a substantially polygonal pyramid shape.

7. The backlight assembly of claim 6, wherein there is a plurality of reflecting structured portions and adjacent reflecting structured portions touch.

8. The backlight assembly of claim 7, wherein a bottom surface of each of the reflecting structured portions have a substantially square shape or a regular triangle shape, and a ratio of a height to a bottom length for each of the reflecting structured portions is about 1.0:4.9 to about 1.0:5.1.

9. The backlight assembly of claim 7, wherein a bottom surface of each of the reflecting structured portions have a substantially square shape or a regular triangle shape, and a ratio of a height to a bottom length of each of the reflecting structured portions is about 1.0:9.9 to about 1.0:10.1.

10. The backlight assembly of claim 7, wherein a bottom surface of each of the reflecting structured portions have a substantially square shape or a regular triangle shape, a ratio of a height to a bottom length of each of the reflecting structured portions is about 1:1, and the height of each of the reflecting structured portions is about 7 mm to about 11 mm.

11. The backlight assembly of claim 1, wherein the reflecting structured portion has a substantially conical shape.

12. The backlight assembly of claim 1, wherein the reflecting structured portion comprises an embossing portion, and each embossing portion has a dome shape.

13. The backlight assembly of claim 12, wherein there is a plurality of embossing portions and adjacent embossing portions contact each other.

14. The backlight assembly of claim 13, wherein a ratio of a height of each of the embossing portions to a radius of a bottom surface of each of the embossing portions is about 1.0:2.9 to about 1.0:3.1.

15. The backlight assembly of claim 12, wherein a ratio of a height of each of the embossing portions, a radius of a bottom surface of each of the embossing portions and an interval between bottom surfaces of adjacent embossing portions is about 1:1:0.7 to about 1:1:0.9.

16. A display device comprising:
a plurality of point light sources generating red, green and blue lights;
an optical member on the point light sources to transmit white light formed by mixing at least some of the red, green and blue lights and to reflect an untransmitted portion of the red, green and blue lights;
a reflecting plate having a plurality of openings through which the point light sources extend and a plurality of patterns for diffusing the untransmitted portion of the red, green and blue lights; and
a display panel that displays an image by using the white light exiting the optical member.

17. The display device of claim 16, wherein the patterns comprise a plurality of reflecting structured portions, and each of the reflecting structured portions has a substantially polygonal pyramid shape.

18. The display device of claim 16, wherein the patterns comprise a plurality of embossing portions, and each of the embossing portions has a dome shape.

19. The display device of claim 16, further comprising:
a receiving container receiving the point light sources, the receiving container including:
a bottom plate; and
a sidewall on a side of the bottom plate to support the display panel; and
a power supply printed circuit board on which the point light sources are mounted.
